(19) United States
(12) Patent Application Publication
(10) Pub. No.: US 2005/0256944 A1
(43) Pub. Date: Nov. 17, 2005

(54) Method for separating multiple home networks

(76) Inventors: Seung Myun Baek, Kyongsangnam-do (KR); Koon Seok Lee, Kyongsangnam-do (KR); Hwan Jong Choi, Kyongsangnam-do (KR); Jeong Hyun Lim, Kyongsangnam-do (KR)

Correspondence Address: MCKENNA LONG & ALDRIDGE LLP, 1900 K STREET, NW, WASHINGTON, DC, 20006, US

(21) Appl. No.: 10/506,431

(22) PCT Filed: Apr. 10, 2002
(86) PCT No.: PCT/KR02/00654

§ 371 Date: Sep. 2, 2004

(30) Foreign Application Priority Data
Apr. 1, 2002 (KR) 2002/17807

(51) Int. Cl. G06F 15/173

(52) U.S. Cl. 709/223

(57) ABSTRACT

A method for separating multiple home networks sharing communication line path is disclosed. The method includes a step for setting a house code so as to divide each home network according to adapters of each product: a step in which each adapter receives a packet once a predetermined packet including the house code is transmitted to the communication line path and then the predetermined house code and a house code include in the packet are compared: and a step in which a corresponding adapter recognizes as a packet transmitted to itself if the house code is consistent as a result of the comparison, and then transmits a corresponding packet to a product connected to itself.

### TECHNICAL FIELD

The present invention relates to a home network system, and more particularly, to a method for identifying multiple home networks sharing a communication line.

### BACKGROUND ART

Currently, the home automation almost comes to a stage to put into practical use, in which home appliances are controlled automatically in a home or far from the home. Though an initial home automation is at a level the appliances are controlled separately by using a telephone line or an infrared ray, without interconnection between the appliances, currently a method is used, in which a network of the appliances are constructed by employing communication means, and a controller for controlling the network is provided, for integrated management of the network.

The home network may be constructed by using an exclusive communication line for each home, or multiple home networks may be constructed by using a power line or a common communication line like a radio communication.

In a case the home networks sharing the communication line are to be constructed, a technology for exact identification of a home network for each home is absolutely required for making reliable and effective communication within entire network.

Presently, related art home networks sharing the communication line are under development, up to a stage to construct a conceptual system merely, but without practical application to each home, with the homes identified effectively.

### DISCLOSURE OF INVENTION

An object of the present invention designed for solving the foregoing problem lies on providing a method for identifying multiple home networks, in which each home network can be identified exactly, for making an effective communication.

These and other objects of the present invention can be achieved by providing a method for identifying multiple home networks including the steps of setting a house code to each of adapters to the home appliances for identifying home networks, receiving a packet including the house code on the communication line at the adapters, and comparing a preset house code to the house code included in the packet, and one of the adapters understanding that the packet is directed to the one of the adapters if the two house codes are in conformity as a result of the comparison, and transferring the packet to one of the home appliances connected thereto.

### BRIEF DESCRIPTION OF DRAWINGS

The accompanying drawings, which are included to provide a further understanding of the invention, illustrate embodiments of the invention and together with the description serve to explain the principles of the invention:

In the drawings:

FIG. 1 illustrates a layout of home networks sharing a communication line in accordance with a preferred embodiment of the present invention;

FIG. 2 illustrates a block diagram of a detail system of the appliances and the power line communication adapters in FIG. 1;

FIGS. 3A-3C illustrate structures of communication packets transmitted in FIG. 1;

FIG. 4 illustrates a flow chart showing the steps of a method for setting a code for identifying multiple home networks of the present invention;

FIGS. 5A-5C illustrate structures of communication packets transmitted in FIG. 4; and

FIG. 6 illustrates a flow chart showing the steps of a method for identifying multiple home networks in accordance with a preferred embodiment of the present invention.

### BEST MODE FOR CARRYING OUT THE INVENTION

Reference will now be made in detail to the preferred embodiments of the present invention, examples of which are illustrated in the accompanying drawings. In explaining the embodiments, the same names and reference symbols will be given to the same parts, and iterative description of the parts will be omitted.

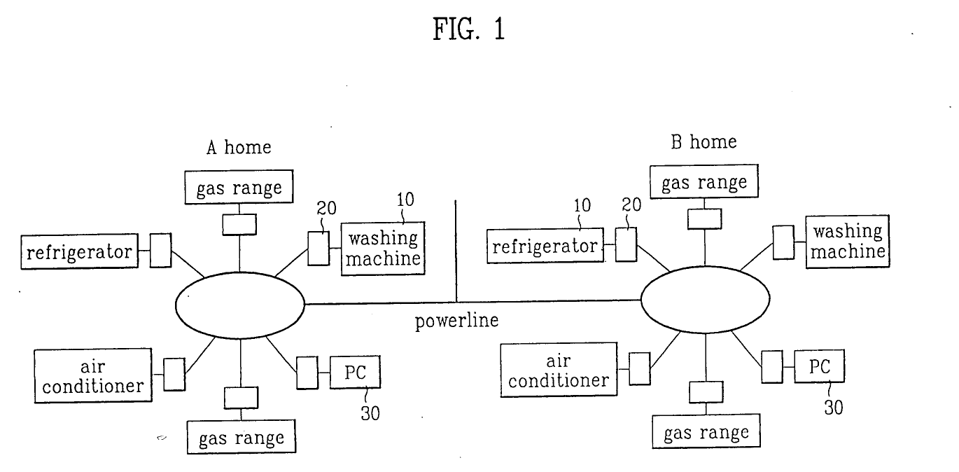

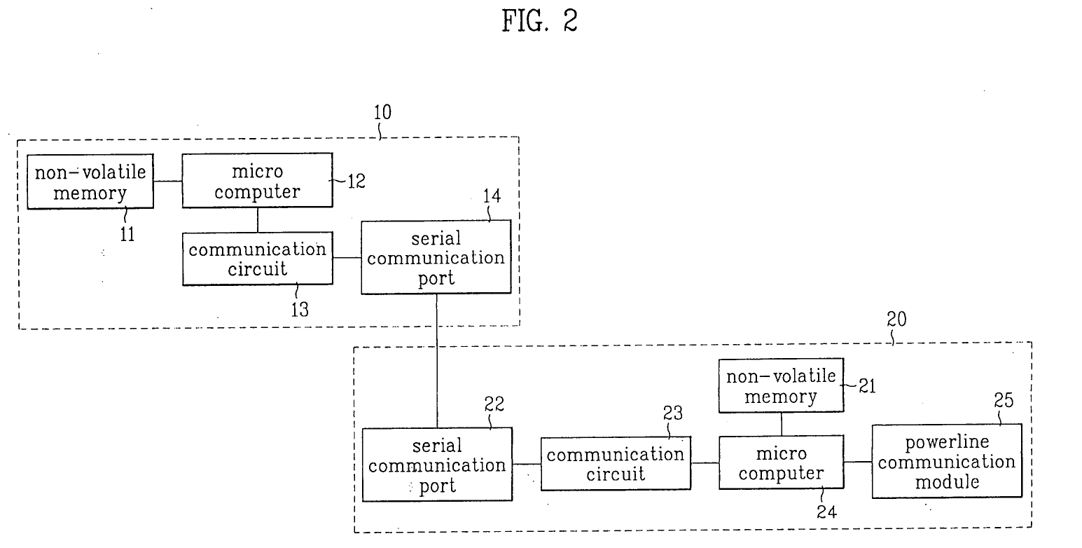

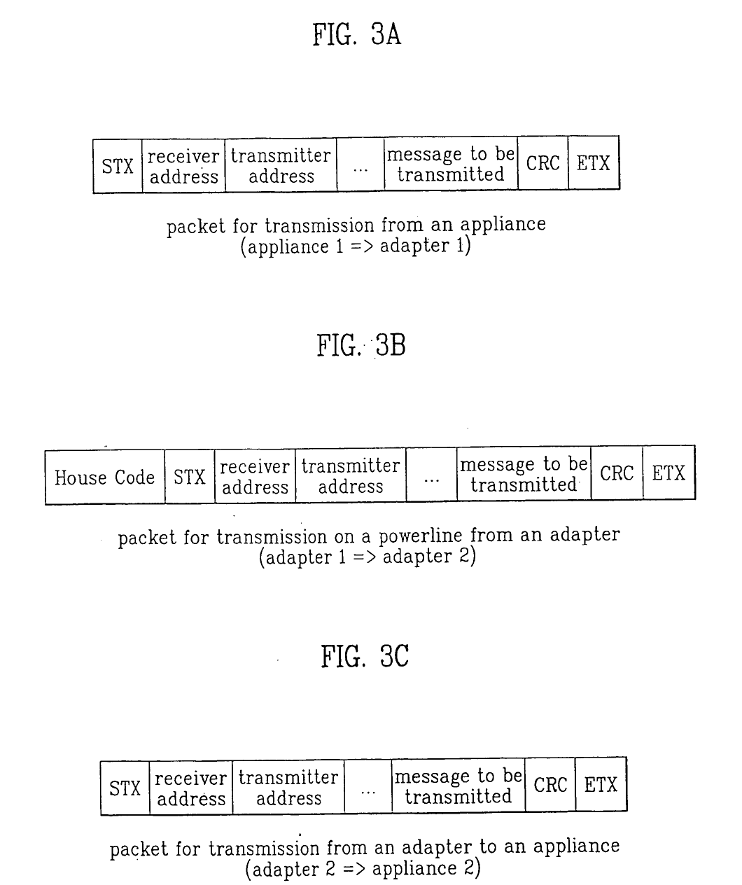

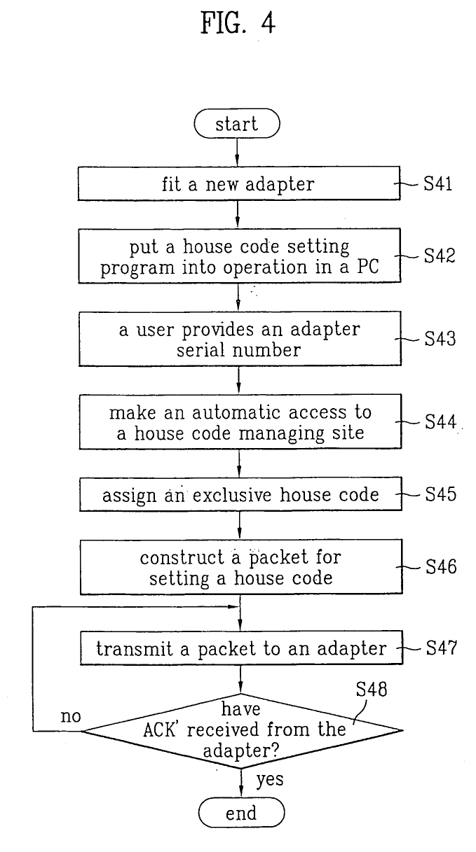

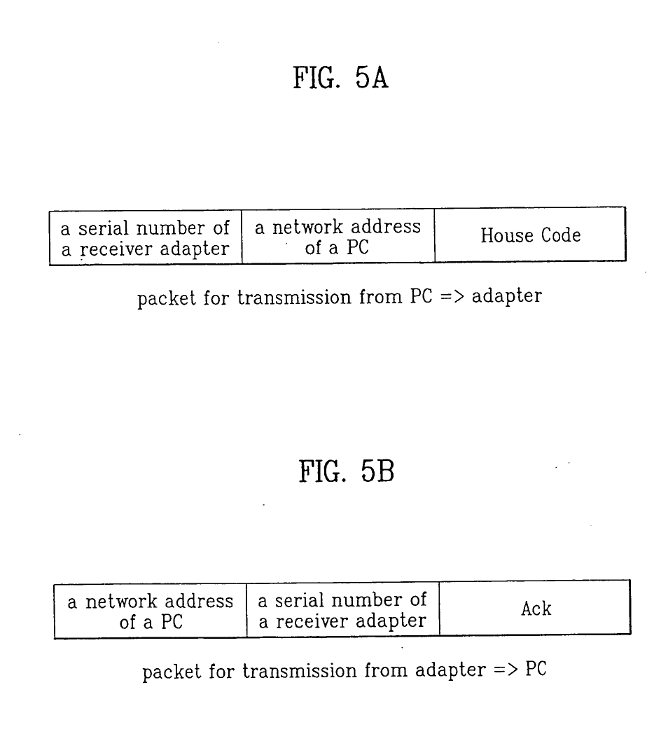

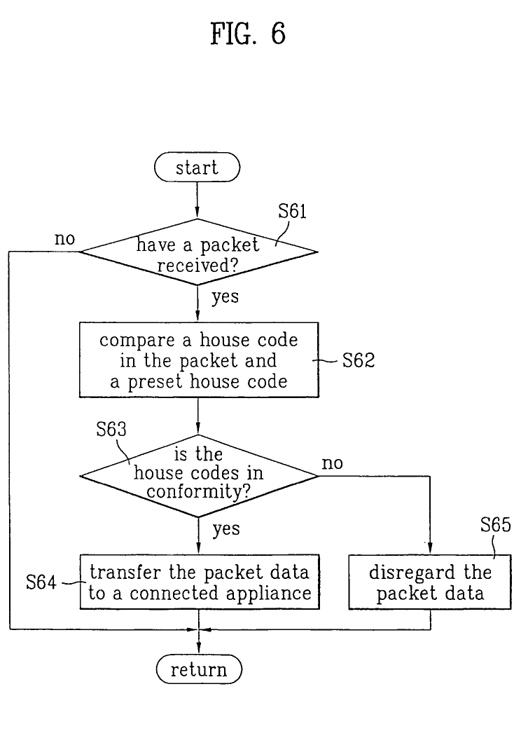

FIG. 1 illustrates a layout of home networks sharing, a communication line in accordance with a preferred embodiment of the present invention, FIG. 2 illustrates a block diagram of a detail system of the appliances and the power line communication adapters in FIG. 1, FIGS. 3A-3C illustrate structures of communication packets transmitted in FIG. 1, FIG. 4 illustrates a flow chart showing the steps of a method for setting a code for identifying multiple home networks of the present invention, FIGS. 5A-5C illustrate structures of communication packets transmitted in FIG. 4, and FIG. 6 illustrates a flow chart showing the steps of a method for identifying multiple home networks in accordance with a preferred embodiment of the present invention.

There are home network systems sharing a communication line of a power line of the present invention illustrated in FIG. 1.

That is, a home ‘A’ and a home ‘B’ have home networks constructed respectively to share a communication line of a power line, with home appliances 10 in each of the homes connected to the power line through a power line communication adapters 20. A PC 30 in each home serves as a controller for controlling the network.

A detailed system of FIG. 1 is illustrated in FIG. 2.

That is, each appliance 10 includes a non-volatile memory 11, a microcomputer 12 for operation of the appliance and communication control, a serial communication port 14 for transmission/reception of data, and each of the adapters 20 includes a nonvolatile memory 21, a serial communication port 22 for communication with the serial communication port 14 of the appliance 10, a communication circuit 23, a communication control microcomputer 24, and a power line communication module 25 for enabling data communication through the power line. The serial communication port 14 of each of the appliances 10 and the serial communication port 22 of the adapter 20 are connected, and the power line communication module 25 of each of the adapters 20 is connected to the power line.

Structures of transmission packets of the appliances of the foregoing home networks are illustrated in FIGS. 3A-3C. Referring to FIG. 3A, a transmission packet from the appliance 10 to the adapter 20 includes an ‘STX (starting code)’, ‘a receiver address’, ‘message to be transmitted’, a ‘CRC’ (an error check code), and ‘ETX (termination code)’. Referring to FIG. 3B, a transmission packet from the adapter 20 to the power line includes a ‘house code’, an ‘STYX’, a ‘receiver address’, a ‘transmitter address’, a ‘message to be transmitted’, a ‘CRC’, and an ‘EXT.’. Referring to FIG. 3C, a transmission packet from the adapter 20 to the appliance 10 includes an ‘STX’, a ‘receiver address’, a ‘transmitter address’, a ‘message to be transmitted’, a ‘CRC’, and an ‘ETX’. That is, the ‘house code’ is added only when a transmission is made through the power line.

At first, it is required that a method for identifying multiple home networks of the present invention is started from setting a house code to each of adapters 20 for identifying respective homes. Accordingly the house code setting will be explained in detail, with reference to FIG. 4.

A user or a service man from a manufacturer connects the adapter 20 to an appliance 10 (S41).

Then, a program for setting a house code is put into operation in a PC 30 (S42). The program may be downloaded through Internet, or provided in a form of a CD or a diskette.

A serial number of the user fitted adapter 200 is provided to the operative program for setting a house code (S43).

Then, when the serial number is provided, the program for setting a house code makes an automatic access to a house code managing site (S44).

Then, the accessed house code managing site assigns its own house code not in use at the present time, and transfers to the PC 30 (S45).

Then, referring to FIG. 5A, the house code setting program in the PC 30 constructs a packet including ‘a receiver adapter serial number’ defining a receiver address, ‘a PC network address’ defining a transmitter address, and ‘the house code’ assigned from the managing site (S46).

Then, the house code setting program transfers the packet to the adapter 20 (S47).

Then, reception of ‘ACK’ from the adapter 20 is determined (S48), and a determination that the house code setting is finished is made and the process is terminated if the ‘ACK’ is received, or the transfer of the packet is repeated if no ‘ACK’ is received.

In this instance, upon reception of the packet as shown in FIG. 5A, the adapter 20 responds with a packet constructed to include ‘a PC network address’ defining a receiver address, ‘a receiver adapter serial number’ defining a transmitter address, and the ‘ACK’ as shown in FIG. 5B.

In the meantime, a method for identifying respective home networks in transmission of the packet after finishing the house code setting as shown in FIG. 4 will be explained, with reference to FIG. 6.

Each of the adapters 20 determines if a packet is received through a power line (S61). If the packet is received as a result of the determination (S61), each of the adapters 20 compares the house code in the packet to the house code set in the setting of the house code (S62).

Then, conformity of the house codes is determined (S63) as a result of the comparison (S62), and the packet is transferred to a connected appliance 20 if the house codes are in conformity (S64).

Opposite to this, if the house codes are not in conformity as the result of the determination (S63), the packet is disregarded (S65).

Eventually, if a packet is transmitted through a common communication line, a power line, only a relevant appliance receives the packet, decodes to carry out a required operation order, without giving influence to other appliances.

It will be apparent to those skilled in the art that various modifications and variations can be made in the method for identifying multiple home networks of the present invention without departing from the spirit or scope of the invention. Thus, it is intended that the present invention cover the modifications and variations of this invention provided they come within the scope of the appended claims and their equivalents.

### INDUSTRIAL APPLICABILITY

The method for identifying multiple home networks having a common communication line can identify a home network in multiple home networks having a common communication line effectively by a simple setting and an algorithm addition without additional hardware, whereby permitting to make an efficient and reliable communication.

1. A method for identifying multiple home networks each having a plurality of home appliances connected to respective adapters and a network controller, and at least two home networks share one communication line, the method comprising the steps of:
setting a house code to each of adapters to the home appliances for identifying home networks;
receiving a packet including the house code on the communication line at the adapters, and comparing a preset house code to the house code included in the packet; and
one of the adapters understanding that the packet is directed to the one of the adapters if the two house codes are in conformity as a result of the comparison, and transferring the packet to one of the home appliances connected thereto.

2. A method as claimed in claim 1, wherein the step of setting a house code includes the step of;
putting a house code setting program into operation in the network controller,
providing a serial number of the adapter and making access to a house code managing site on the Internet in the program,
receiving an own house code assigned from the house code managing site and transferring to a relevant adapter, and
the adapter storing the house code to a relevant memory region.

3. A method as claimed in claim 2, wherein the step of providing a serial number of the adapter and making access to a house code managing site on the Internet in the program includes the step of making an automatic access to the house code managing site once the serial number for the adapter is provided.

4. A method as claimed in claim 1, further comprising the step of the adapters disregarding the received packet if the two house codes are not in conformity as the result of comparison.
